(19) United States
(12) Patent Application Publication
(10) Pub. No.: US 2009/0245658 A1
(43) Pub. Date: Oct. 1, 2009

(54) COMPUTER-READABLE RECORDING MEDIUM HAVING CHARACTER RECOGNITION PROGRAM RECORDED THEREON, CHARACTER RECOGNITION DEVICE, AND CHARACTER RECOGNITION METHOD

(75) Inventor: Katsuhito FUJIMOTO, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/396,961

(22) Filed: Mar. 3, 2009

(30) Foreign Application Priority Data
Mar. 28, 2008 (JP) 2008-088339
Aug. 28, 2008 (JP) 2008-220424

(51) Int. Cl. G06K 9/68

(52) U.S. Cl. 382/218

(57) ABSTRACT

A character recognition method and device including extracting a character pattern based on information of an input character image and information about a structure of a character category and comparing the extracted character pattern with the character category corresponding to the character pattern to calculate the similarity, where the character category is representative of a character to be output after recognition of the input character image. The method and device include outputting as a recognition result of the input character image the character category with a maximum similarity obtained by the calculation or information of characters which are candidates of the character category whose similarities have been calculated.

### CROSS-REFERENCE TO RELATED APPLICATIONS

This application is based upon and claims the benefit of priority of the prior Japanese Patent Application No. 2008-088339, filed on Mar. 28, 2008 and the prior Japanese Patent Application No. 2008-220424, filed on Aug. 28, 2008, the entire contents of which are incorporated herein by reference.

### FIELD

The embodiments discussed herein are related to character recognition.

### BACKGROUND

Generally, when character recognition is implemented by a scanner or the like, low-resolution images (for example, “150 to 200 dpi”) are used in color document images for the purpose of capacity reduction and higher scanning speed. There has been an increasing demand for a technique for performing recognition with high accuracy supporting various character patterns in such low-resolution color images and also in low-resolution images such as black-and-white images and gray images.

As the technique for recognizing a low-resolution image, there is a technique of binarizing a color image or a gray image to extract a character pattern expressed by a black and white binary pattern and calculating a similarity between the extracted character pattern and a standard pattern of a character stored in a feature dictionary using the extracted character pattern and the feature dictionary, whereby a character corresponding to an input image is recognized.

In addition, when the color image or the gray image is binarized, a method such as “background discrimination Niblack binarization” and “contrast-free binarization” for extracting a portion darker than a background as a stroke (such as a vertical segment and a horizontal segment) is used. These methods are used for outputting a darker portion (black color) than a background image (white color) when a degraded gray image is binarized. FIG. 23 depicts examples of a character pattern output by these binarization methods. As depicted in FIG. 23, the character pattern has a portion difficult to be discriminated from the background image due to thin segments and congestion of segments, etc., resulting in the occurrence of collapse and blurring of a character. Thus, the recognition accuracy of the character recognition based on these binarization methods is low.

### SUMMARY

According to an aspect of an embodiment, a character recognition method and device includes extracting a character pattern, which is compared with a character category representing a character to be output after recognition of an input character image in the recognition of the input character image, based on information of the input character image and information about a structure of the character category. The character recognition method and device include comparing the extracted character pattern with the character category corresponding to the character pattern to calculate the similarity and outputting as a recognition result of the input character image the character category with a maximum similarity obtained by the calculation or information of characters which are candidates of the character category whose similarities have been calculated.

Additional aspects and/or advantages will be set forth in part in the description which follows and, in part, will be apparent from the description, or may be learned by practice of the invention. The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

These and/or other aspects and advantages will become apparent and more readily appreciated from the following description of the embodiments, taken in conjunction with the accompanying drawings of which:

FIG. 1 depicts an outline and characteristic(s) of a character recognition device according to an embodiment;

FIG. 2 depicts a configuration of a character recognition device according to an embodiment;

FIG. 3 depicts an example of information stored in a character structure dictionary storage part;

FIG. 4 depicts an example of information stored in a character recognition dictionary storage part;

FIG. 5 is a flow chart for explaining a character recognition processing by a character recognition device according to an embodiment;

FIG. 6 is a flow chart for explaining in detail a character pattern extraction processing according to an embodiment;

FIG. 7 explains an area information acquisition processing in a character image according to an embodiment;

FIG. 8 explains a smoothing processing of boundary value information using sigmoid function, according to an embodiment;

FIG. 9 explains acquisition of a black area evaluation value according to an embodiment;

FIG. 10 depicts an outline of a character recognition device according to an embodiment;

FIG. 11 depicts a configuration of the character recognition device according to an embodiment;

FIG. 12 depicts an example of information stored in a character structure dictionary storage part;

FIG. 13 explains positional information of a character category [symbol] ;

FIG. 14 explains positional information of a character category [symbol] ;

FIG. 15 is a flow chart for explaining a character recognition processing by a character recognition device according to an embodiment;

FIG. 16 depicts an outline of a character recognition device according to an embodiment;

FIG. 17 depicts a configuration of a character recognition device according to an embodiment;

FIG. 18 depicts an example of information stored in an inclusion character storage part;

FIG. 19 depicts an image of a digraph in inclusion characters;

FIG. 20 is a flow chart for explaining a character recognition processing by an character recognition device according to an embodiment;

FIG. 21 is a flow chart depicting a flow of a character recognition processing using similarity calculation and/or evaluation value calculation and inclusion character output;

FIG. 22 depicts an exemplary computer for executing a character recognition program;

FIG. 23 depicts examples of a character pattern output by binarization according to prior arts; and

FIG. 24 depicts a character category in which the similarity becomes high in the case where an input image is [symbol] .

### DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

Hereinafter, embodiments of a character recognition device according to the present invention are described in detail with reference to the attached drawings. In the following embodiments, an outline and characteristic(s) of the character recognition device according to the present invention, a configuration of the character recognition device, and the flow of a character recognition processing are sequentially described. The effects of the present embodiments are finally described.

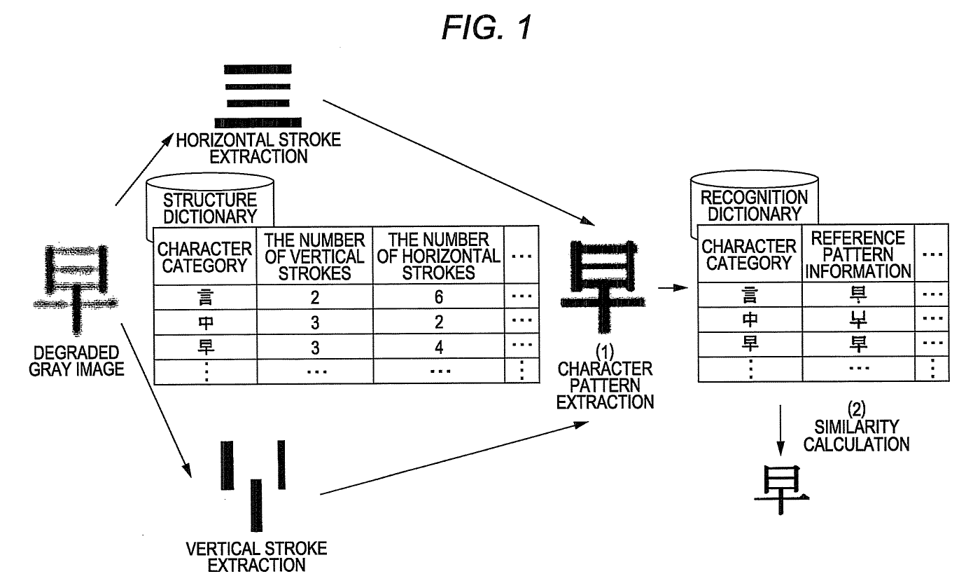

First, the outline and characteristic(s) of a character recognition device according to an embodiment are described using FIG. 1. FIG. 1 depicts the outline and characteristic of the character recognition device according to an embodiment.

This character recognition device recognizes a character image input from a predetermined device, a predetermined medium or the like and outputs a character corresponding to the character image. The input character image includes, for example, a color image, a black-and-white image, and a degraded gray image, and/or any other kind of image may be applied.

In the above configuration, the outline of the character recognition device is to recognize the input character image and output the recognition result. Specifically, the character recognition device is mainly characterized in that high accuracy character recognition can be realized. Hereinafter, a case where the input character image is a degraded gray image is described.

The character recognition device includes a character structure dictionary storage part for storing information about structures of character categories, each representing a character to be output after recognition of an input character image, in association with the respective character categories. Further, the character recognition device includes a character recognition dictionary storage part for storing character patterns, which are compared with the character categories in the recognition of the input character image, in association with the respective character categories.

In this state, the character recognition device extracts a character pattern based on information of the input character image and the information about the structure of a character category stored in the character structure dictionary storage part to store the character pattern in the character recognition dictionary storage part (see, FIG. 1 (1)).

Specifically, the character recognition device extracts vertical strokes and horizontal strokes from the input degraded gray image, for example, [symbol] by using the number of vertical strokes “2” and the number of horizontal strokes “6” which is information about the structure of a character category [symbol] stored in the character structure dictionary storage part. The character recognition device then combines the extracted vertical and horizontal strokes with each other and extracts a character pattern of the input degraded gray image [symbol] . Subsequently, the character recognition device stores the extracted character pattern in the character recognition dictionary storage part in association with the character category [symbol] .

In addition, the character recognition device extracts the vertical strokes and the horizontal strokes from the input degraded gray image, for example, [symbol] by using the number of vertical strokes “3” and the number of horizontal strokes “2” which is information about the structure of a character category [symbol] stored in the character structure dictionary storage part. The character recognition device then combines the extracted vertical and horizontal strokes with each other and extracts a character pattern of the input degraded gray image [symbol] . Subsequently, the character recognition device stores the extracted character pattern in the character recognition dictionary storage part in association with the character category [symbol] .

Further, the character recognition device extracts the vertical strokes and the horizontal strokes from the input degraded gray image [symbol] by using the number of vertical strokes “3” and the number of horizontal strokes “4” which is information about the structure of a character category [symbol] stored in the character structure dictionary storage part. The character recognition device then combines the extracted vertical and horizontal strokes with each other and extracts a character pattern of the input degraded gray image [symbol] . Subsequently, the character recognition device stores the extracted character pattern in the character recognition dictionary storage part in association with the character category [symbol] .

If the character pattern extraction is applied to all character categories stored in the character structure dictionary storage part, a great amount of processing time will be required, and therefore, the number of the character categories corresponding to the character patterns extracted from the input character image is limited to some extent by using known technique(s). Namely, the character recognition device applies a conventionally used character recognition processing to the input character image, determines the resulting candidates obtained from the character recognition processing as the character categories, and extracts the character patterns by using the structural information of the character categories.

The character recognition device then compares the character patterns stored in the character recognition dictionary storage part with the respective character categories corresponding to the character patterns to calculate the similarities. The character recognition device then outputs as the recognition result of the input character image the character category with the maximum similarity obtained by the calculation or the information of the characters which are the candidates of the character category whose similarities have been calculated (see, FIG. 1 (2)).

The character recognition device compares the character pattern of the degraded gray image, for example, [symbol] stored in the character recognition dictionary storage part with the character category [symbol] corresponding to the character pattern to calculate the similarity. In addition, the character recognition device compares the character pattern of the degraded gray image [symbol] stored in the character recognition dictionary storage part with the character category [symbol] corresponding to the character pattern to calculate the similarity. Further, the character recognition device compares the character pattern of the degraded gray image [symbol] stored in the character recognition dictionary storage part with the character category [symbol] corresponding to the character pattern to calculate the similarity.

The character recognition device then outputs as the recognition result of the input degraded gray image [symbol] the character category [symbol] with the maximum similarity obtained by the above calculation. As the recognition result of the input character image, the character codes such as the characters [symbol] and [symbol] which are the candidates of the character category whose similarities have been calculated and the information of the calculated similarities and the like may be output.

The character recognition device repeatedly applies the character pattern extraction processing and the similarity calculation processing to the input character image by the number of times corresponding to the number of character categories to be compared and classified. The character recognition device then outputs as the recognition result of the input character image the character category with the maximum similarity among the similarities calculated for all the character categories to be compared and classified.

Thus, when the character recognition device according to an embodiment recognizes an input character image and outputs the recognition result, it can extract character patterns by using the structural information of character categories to be compared and classified with respect to the input character image and output as the recognition result of the input character image a character category with the maximum similarity between the extracted character pattern and the character category corresponding to the character pattern, whereby high accuracy character recognition can be realized.

Namely, since the character recognition device extracts character patterns using the structural information of various character categories when it recognizes an input character image and outputs the recognition result, it can realize high accuracy character recognition without causing collapse, blurring, etc. even in complex characters as compared with the prior art in which collapse and blurring occur in characters, especially in complex characters. Thus, the character recognition device outputs as a result of applying a background discrimination on an input character image.

In other words, even in an input character image having a collapsed or blurred vertical or horizontal segment when output as a result of background discrimination, the numbers of vertical and horizontal segments which are the structural information of the character category are known, and therefore, the character recognition device outputs the character recognition result, always using the numbers of the segments. As a result, the character recognition device realizes high accuracy character recognition without causing collapse and blurring of characters even in recognition of complex characters.

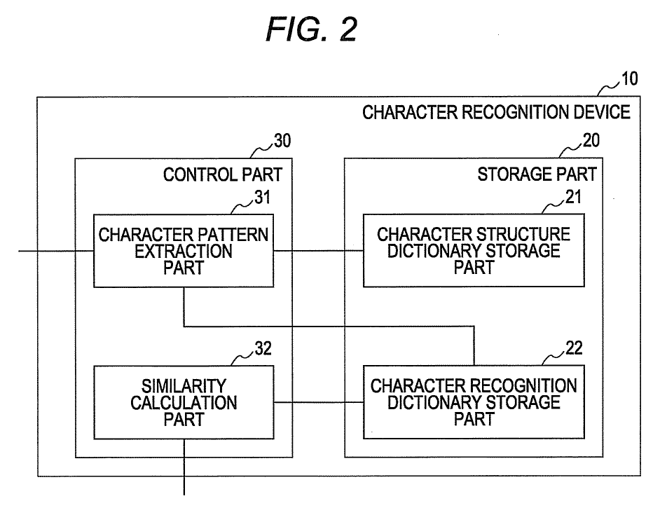

Next, the configuration of the character recognition device according to an embodiment is described using FIG. 2. FIG. 2 depicts a configuration of the character recognition device according to an embodiment.

As depicted in FIG. 2, the character recognition device 10 includes a storage part 20 and a control part 30. The character recognition device 10 recognizes a character image input from a scanner, a medium, or the like connected to the character recognition device 10 and outputs the character of the character image.

The storage part 20 stores data required for various processing performed by the control part 30 and various processing result(s) from the control part 30, and, in particular, includes a character structure dictionary storage part 21 and a character recognition dictionary storage part 22 which are closely associated with the present invention.

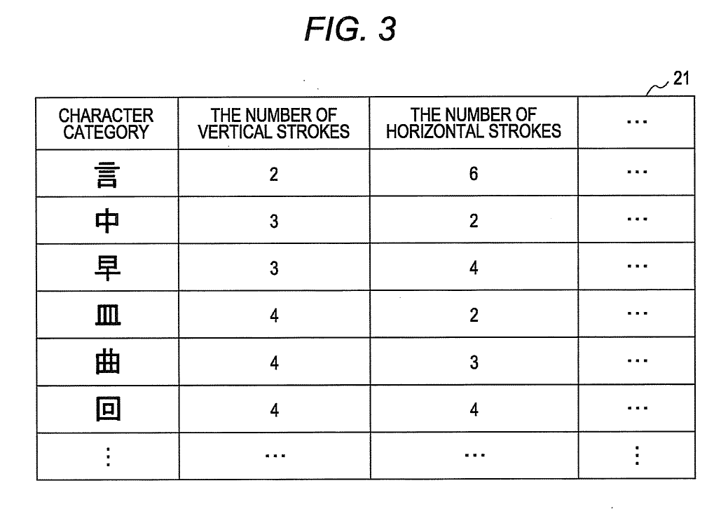

The character structure dictionary storage part 21 stores information about the structure(s) of the character category(ies) in association with respective character category(ies), each of which represents a character to be output after recognition of an input character image. For example, the character structure dictionary storage part 21, as depicted in FIG. 3, stores information about a structure including a number of vertical strokes, for example, “3” and the number of horizontal strokes, for example, “4” of the character category [symbol] in association with the character category [symbol] representing the character to be output after recognition of the input character image [symbol] . FIG. 3 depicts an example of information stored in the character structure dictionary storage part 21.

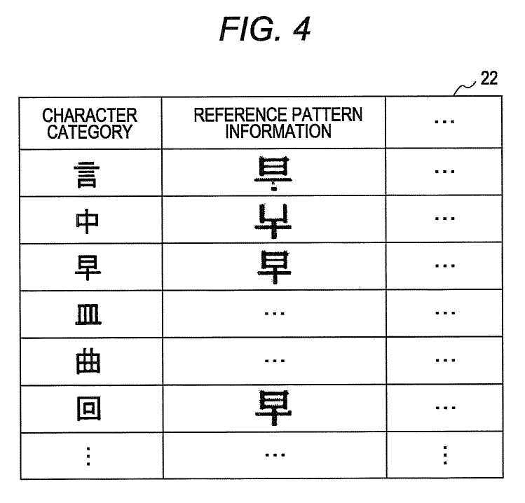

The character recognition dictionary storage part 22 stores character patterns, which are compared with the character categories in the recognition of the input character image, in association with the respective character categories. For example, the character recognition dictionary storage part 22, as depicted in FIG. 4, stores a character pattern, which is compared with the character category [symbol] in the recognition of the input character image [symbol] , in association with the character category [symbol] . FIG. 4 depicts an example of information stored in the character recognition dictionary storage part 22.

The control part 30 includes an internal memory for storing control program(s), programs specifying procedure(s) of various processing or the like, and required data. In particular, the control part 30 includes a character pattern extraction part 31 and a similarity calculation part 32, which are closely associated with the present invention, and performs various processing by using these parts.

The character pattern extraction part 31 extracts a character pattern based on information of the input character image and the information about the structure of the character category stored in the character structure dictionary storage part 21 and the extracted character pattern is stored in the character recognition dictionary storage part 22.

Specifically, for example, the character pattern extraction part 31 extracts the vertical strokes and the horizontal strokes from the input character image [symbol] by using the number of vertical strokes “3” and the number of horizontal strokes “4” which are the information about the structure of the character category [symbol] stored in the character structure dictionary storage part 21.

The character pattern extraction part 31 combines the extracted vertical and horizontal strokes with each other and extracts a character pattern of the input character image [symbol] . Subsequently, the character pattern extraction part 31 stores the extracted character pattern in the character recognition dictionary storage part 22 in association with the character category [symbol] .

The character pattern extraction part 31 applies the character pattern extraction processing to the character categories such as [symbol] and [symbol] , which will be compared and classified with respect to the input character image [symbol] . The character pattern extraction part 31 thus extracts a plurality of character patterns to store the extracted character patterns in the character recognition dictionary storage part 22.

The similarity calculation part 32 compares the character patterns, which are stored in the character recognition dictionary storage part 22 by the character pattern extraction part 31, with the respective character categories corresponding to the character patterns to calculate the similarities. The similarity calculation part 32 then outputs as the recognition result of the input character image the character category with the maximum similarity obtained by the calculation or the information of the characters which are the candidates of the character category whose similarities have been calculated.

When it is specifically described using the above example, the similarity calculation part 32 compares the character pattern of the character image [symbol] stored in the character recognition dictionary storage part 22 by the character pattern extraction part 31, with the character category [symbol] corresponding to the character pattern to calculate the similarity. Further, the similarity calculation part 32 compares the character patterns such as [symbol] and [symbol] stored in the character recognition dictionary storage part 22 by the character pattern extraction part 31, with the character categories of the character patterns such as [symbol] and [symbol] to calculate the respective similarities.

The similarity calculation part 32 then outputs as the recognition result of the input character image [symbol] the character category [symbol] with the maximum similarity obtained by the above calculation. As the recognition result of the input character image, character codes of the characters such as [symbol] and [symbol] , which are the candidates of the character category whose similarities have been calculated, and the information including the calculated similarities may be output.

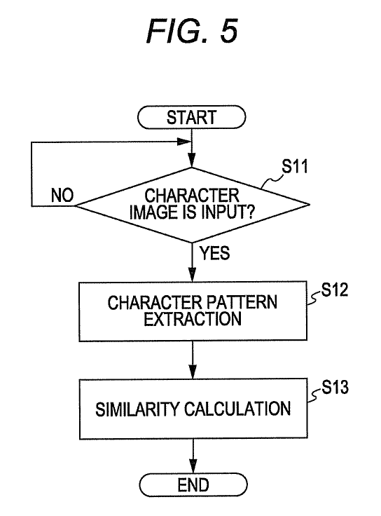

Next, a character recognition processing, for example, by the character recognition device 10 according to an embodiment is described using FIG. 5. FIG. 5 is a flow chart for explaining the character recognition processing by the character recognition device 10 according to an embodiment.

As depicted in FIG. 5, when a character image is input from a predetermined device, a predetermined medium, or the like (Yes in operation S11), the character recognition device 10 extracts a character pattern based on information of the input character image and information about a structure of a character category stored. The character category structure information may be stored in the character structure dictionary storage part 21. The extracted character pattern is stored in the character recognition dictionary storage part 22 (operation S12). While input of a character image from a predetermined medium or device is discussed, the present invention is not limited to input from any particular source.

For example, when a character image is input from a scanner, a medium (CD-R), or the like, the character recognition device 10 extracts vertical stroke(s) and horizontal stroke(s) from an input degraded gray image, for example, [symbol] by using the number of vertical strokes “3” and the number of horizontal strokes “4” which is the information about the structure of the character category [symbol] stored in the character structure dictionary storage part 21.

The character recognition device 10 then combines the extracted vertical strokes and the horizontal strokes with each other and extracts the character pattern of the input degraded gray image [symbol] . Subsequently, the character recognition device 10 stores the extracted character pattern in the character recognition dictionary storage part 22 in association with the character category [symbol] .

The character recognition device 10 then compares the character patterns stored in the character recognition dictionary storage part 22 with the respective character categories corresponding to the character patterns to calculate the similarities. The character recognition device 10 then outputs as the recognition result of the input character image the character category with the maximum similarity obtained by the calculation or information of the characters which are the candidates of the character category whose similarities have been calculated (operation S13).

For example, the character recognition device 10 compares the character pattern of the degraded gray image [symbol] stored in the character recognition dictionary storage part 22 with the character category [symbol] corresponding to the character pattern to calculate the similarity. The character recognition device 10 then outputs as the recognition result of the input degraded gray image [symbol] the character category [symbol] with the maximum similarity obtained by the calculation.

As the recognition result of the input degraded gray image [symbol] , the character codes of the characters (for example, [symbol] and [symbol] ) which are the candidates of the character category whose similarities have been calculated or the information including the calculated similarities may be output in addition to the character category [symbol] .

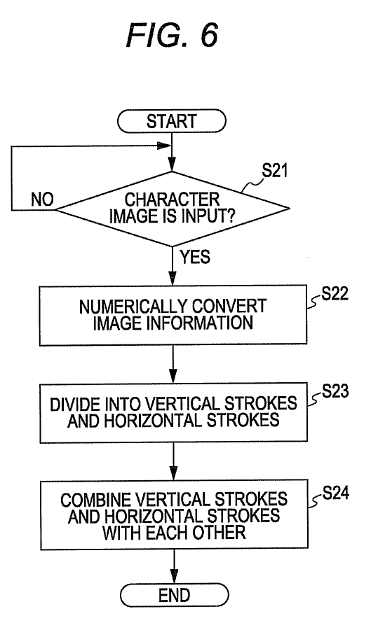

Next, a character pattern extraction processing according to an embodiment is described in detail using FIG. 6. FIG. 6 is a flow chart for explaining in detail the character pattern extraction processing according to an embodiment. The character pattern extraction processing described below corresponds to the processing in operation S12 depicted in FIG. 5.

As depicted in FIG. 6, when a character image is input (Yes in operation S21), the character recognition device 10 numerically converts image information. Specifically, the input character image into a white area range and a black area range (operation S22).

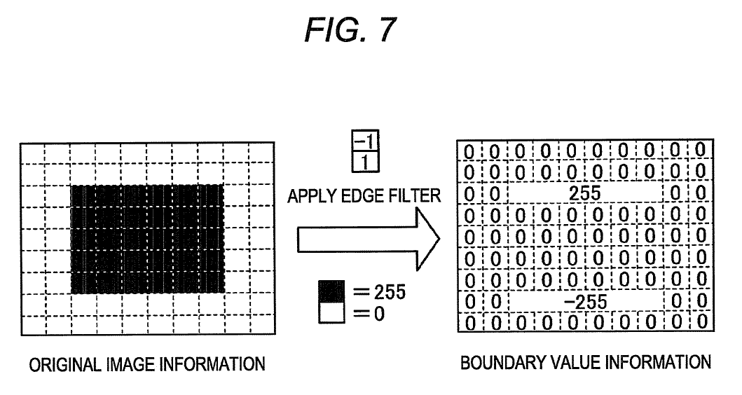

Specifically, when the character image is input from a scanner, a medium (CD-R), or the like, the character recognition device 10 converts the input character image into a gray image in which the white area range in the input image is “0” and the black area range is “255”. Then, as depicted in FIG. 7, the character recognition device 10 applies an edge filter to the information of the input character image (original image information) to calculate a boundary value in the character image, and determines information of the calculated boundary value as numerical information of the character image. FIG. 7 explains an area information acquisition processing in a character image, according to an embodiment.

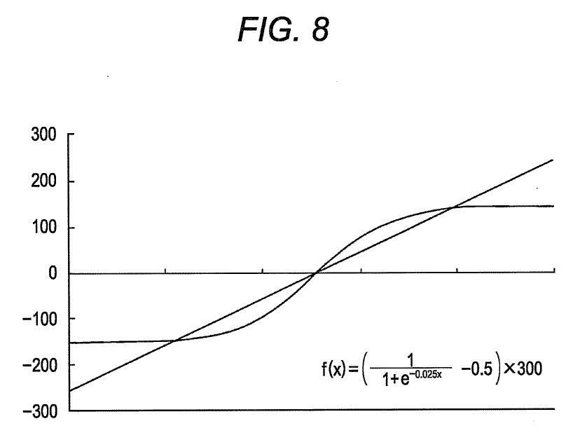

Since the calculated boundary value information is the numerical information strongly holding the influence of image degradation, the character recognition device 10 smoothes the numerical information by using the sigmoid function as illustratively depicted in FIG. 8 so that week boundary value information becomes as strong as possible or so that strong boundary value information is weakened to a certain value. FIG. 8 explains the smoothing processing of the boundary value information using the sigmoid function, according to an embodiment.

The character recognition device 10 detects the segments of the input character image by dynamic programming based on the information obtained by numerically converting the input character image and the information about the numbers of the vertical and horizontal segments of the character category stored in the character structure dictionary storage part 21 (operation S23) and extracts the character pattern to store the extracted character pattern in the character recognition dictionary storage part 22 (operation S24).

When it is specifically described using the above example, the character recognition device 10 detects the character stroke(s) in the input character image by a calculation formula using the dynamic programming depicted in the following formula (1) based on information obtained by numerically converting the input character image and information about the numbers of the vertical and horizontal segments of the character category stored in the character structure dictionary storage part 21. The character strokes in the character image are detected by calculating a maximum evaluation value by using the formula (1).

$$E = Wx ( {Y}_{0} ) + Bx ( {Y}_{1} ) + Wx ( {Y}_{2} ) + … + Wx ( {Y}_{N} ) \{ \begin{matrix}{Y}_{0} = 0 \leq y \leq {ys}_{0} - 1 \\ {Y}_{1} = {ys}_{0} \leq y \leq {ye}_{1} - 1 \\ {Y}_{2} = {ys}_{1} \leq y \leq {ye}_{2} - 1 \\ ⋮ \\ {Y}_{N} = {ye}_{N} \leq y \leq N\end{matrix} \qquad ( 1 )$$

The white area evaluation value (for example, “Wx (Y₀)”) in the X coordinate range (xs, xe) and the Y coordinate range (ys, ye) depicted in the formula (1) is calculated by a calculation formula using an average value of each cell of the boundary information as depicted in the following formula (2):

$$W ( X , Y ) = - EdgeAve ( X , Y ) \{ \begin{matrix}X = xs \leq x \leq xe \\ Y = ys \leq y \leq ye\end{matrix} \qquad ( 2 )$$

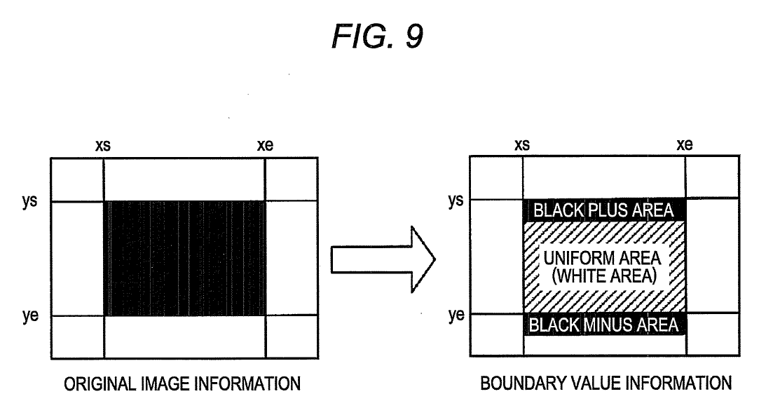

The black area evaluation value (for example, “Bx (Y₁)”) depicted in the formula (1) is calculated based on an average value of each cell as with the white area evaluation value. The boundary value of the black area in the black area evaluation value, as depicted in FIG. 9, is classified into three areas of “black plus area”, “uniform area (white area)” and “black minus area”. Thus, as depicted in the following formula (3), the black area evaluation value is calculated by the sum of the evaluation value “Bu” in the black plus area, the evaluation value “Bd” in the black minus area, and the evaluation value “Wc” in the uniform area (white area). FIG. 9 explains acquisition of a black area evaluation value according to an embodiment.

$$\begin{matrix}Bu ( X , Yu ) = + EdgeAve ( X , Yu ) \\ Wc ( X , Yc ) = - EdgeAve ( X , Yc ) \\ Bd ( X , Yd ) = - EdgeAve ( X , Yd )\end{matrix} \{ \begin{matrix}X = xs \leq x \leq xe \\ Yu = y = ys \\ Yc = ys + 1 \leq y \leq ye \\ Yd = y = ye + 1\end{matrix} \qquad ( 3 )$$

Namely, the character recognition device 10 calculates the white area evaluation values from “Y₀” to “Y_{N}” in the formula (1) by using the formula (2) and calculates the black area evaluation values from “Y₀” to “Y_{N}” by using the formula (3), and thus calculates the maximum evaluation value, whereby the character recognition device 10 detects the character strokes in the input character image. Thereafter, the character recognition device 10 combines the detected character strokes with each other to extract the character pattern, and stores the extracted character pattern in the character recognition dictionary storage part 22.

As described above, according to an embodiment, when the character recognition device 10 recognizes an input character image and outputs the recognition result, it can extract the character patterns by using the structural information of the character categories to be compared and classified with respect to the input character image and calculate respective similarities between the extracted character patterns and the character categories corresponding to the character patterns. The character recognition device 10 then can output as the recognition result of the input character image the character category with the maximum similarity obtained by the calculation, whereby high accuracy character recognition can be realized.

For example, when the character recognition device 10 recognizes an input character image and outputs the recognition result, it extracts the vertical strokes and the horizontal strokes from the input character image [symbol] by using the number of vertical strokes “3” and the number of horizontal strokes “4” which are the information about the structure of the character category [symbol] . The character recognition device 10 then combines the extracted vertical and horizontal strokes with each other and extracts the character pattern of the input character image [symbol] . Subsequently, the character recognition device 10 compares the extracted character pattern of the character image [symbol] with the character category [symbol] corresponding to the character pattern to calculate the similarity. Thereafter, the character recognition device 10 outputs as the recognition result of the input character image [symbol] the character category [symbol] with the maximum similarity obtained by the calculation. As a result, the character recognition device 10 can realize high accuracy character recognition.

In the embodiment discussed above, when a character pattern is extracted, an evaluation value of the white area range and an evaluation value of the black area range are calculated by the dynamic programming, and the character category with a maximum evaluation value is output; however, the present invention is not limited thereto. The extraction of a character pattern may be such that the evaluation value of the white area range and the evaluation value of the black area range are calculated by the dynamic programming, and the black area evaluation value is added depending on the length of the segment, whereby the character category with the maximum evaluation value is output.

Thus, in an embodiment, the character pattern extraction processing by the character recognition device 10 according to an embodiment is described using formulae (4) to (6). In the character recognition device 10 according to an embodiment, the description of each component and some functions which are the same as those in the above discussed embodiment is not repeated. The character pattern extraction processing using two-stage dynamic programming, different from the above discussed embodiment, is particularly described.

In a natural image such as a degraded gray image acquired by a scanner, a digital camera, or the like, it is generally known that the gray value is hardly a constant value due to an acquisition resolution, taking conditions and the like compared with an artificial image. In obtaining the boundary value in such a state and calculating the black area evaluation value using the formula (3), an area in the input character image where the segment should be actually long and continued may receive a high evaluation only in a short continued area, due to the gray level, and therefore, the continued area which is as long as possible should receive a high evaluation. Thus, when the evaluation value is calculated, in order to highly evaluate the long continued area, an added component “B1 (X)” is calculated as depicted in the following formula (4):

B1(X)=1.0+((xe−xs)*0.1) (4)

In the calculation of the black area evaluation value by the character recognition device 10, since the color of the uniform area (white area) depicted in FIG. 9 is not white, a point is added to the black area evaluation value, using the gray level of the uniform area, and an evaluation value “Bs (X, Y)” calculated from the gray level of the input character image is calculated as depicted in the following formula (5):

$$Bs ( X , Y ) = ShadeAve ( X , Y ) - ShadeAve ( {X}_{All} , {Y}_{All} ) \{ \begin{matrix}X = xs \leq x \leq xe , & {X}_{All} = 0 \leq x \leq M \\ Y = ys \leq y \leq ye , & {y}_{All} = 0 \leq y \leq N\end{matrix} \qquad ( 5 )$$

Using the formulae (4) and (5), the character recognition device 10 calculates the black area evaluation value by calculating a final black area evaluation value “B (X, Y)” in an area (X, Y) as depicted in the following formula (6). Further, the character recognition device 10 extracts segments with the maximum calculated evaluation value as the character pattern and outputs as the recognition result of the input character image a character category with the maximum similarity between the extracted character pattern and the character category corresponding to the character pattern. The similarity includes a distance value (distance vector between a character pattern and a character category), a discriminant function value and the like for measuring the similarity of the character obtained by a black and white character recognition.

B(X, Y)=Wc+(Bu+Bd+Bs)*B1 (6)

As described above, when the character recognition device 10 according to an embodiment recognizes the input character image and outputs the recognition result, it can detect the segments of the input character image by the dynamic programming based on the information obtained by numerically converting the input character image into the white area range and the black area range and the information about the number of the vertical and horizontal segments of the character category, extract the character pattern to which the black area is added depending on the length of the segments, and calculate the distance value between the extracted character pattern and the character category corresponding to the character pattern. The character recognition device 10 then can output as the recognition result of the input character image the character category with the closest distance value obtained by the calculation or the information of the characters which are the candidates of the character category whose distance values have been calculated, whereby a higher accuracy of the character recognition can be stably realized.

Namely, when the character recognition device 10 recognizes the input character image and outputs the recognition result, the character recognition device 10 calculates the final black evaluation value for the vertical and horizontal segments of the character category, which will be compared and classified with respect to the input character image, by using the added component in order to highly evaluate the long continued area, whereby a higher accuracy of the character recognition can be stably realized.

In the above discussed embodiments, the similarity is calculated based on the numbers of the vertical and horizontal segments of the input image and the length of the segments; however, the present invention is not limited thereto. The similarity may also be calculated based on the positional information of the vertical and horizontal segments of the input image.

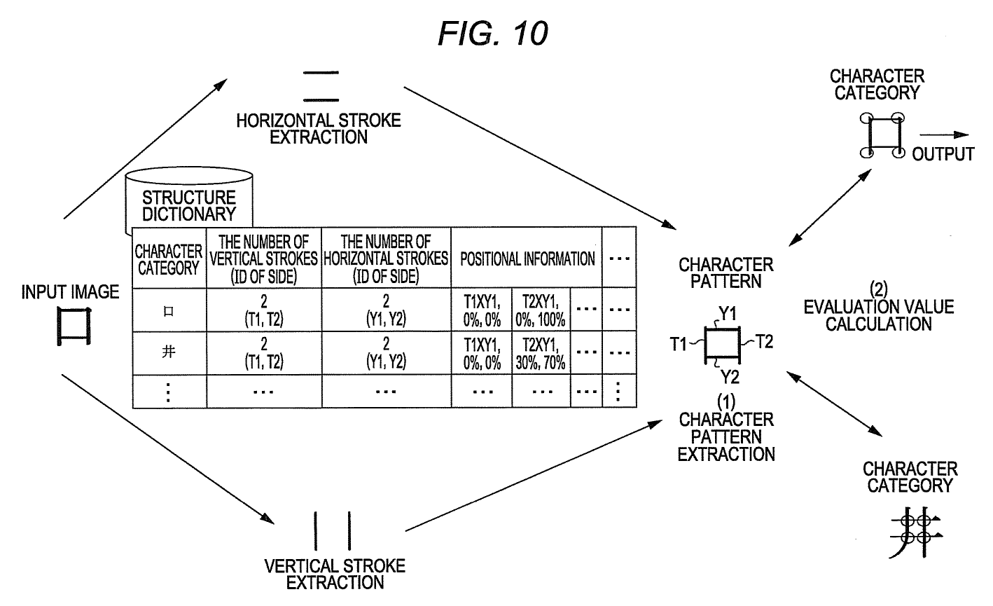

Thus, in an embodiment described below, the similarity is calculated based on positional information of vertical and horizontal segments of the input image. FIGS. 10 to 15 are used for the description.

First, the outline of the character recognition device 10 according to an embodiment is described using FIG. 10. FIG. 10 depicts the outline of the character recognition device 10 according to an embodiment. In the following case, the character image [symbol] is input.

In the character recognition device 10, the information about the structures of character categories is stored in a structure dictionary storage part in association with the character categories, each of which representing a character to be output after recognition of the input character image. The character recognition device 10 then extracts a character pattern, which is compared with the character category in the recognition of the input character image, based on the information of the input character image and the information about the structure of the character category stored in the structure dictionary storage part (see, FIG. 10 (1)).

Specifically, the character recognition device 10 extracts the vertical strokes and the horizontal strokes from the input character image, for example, [symbol] by using the number of vertical strokes, for example, “2” and the number of horizontal strokes, for example, “2” which is information about the structure of the character category [symbol] stored in the character structure dictionary storage part. The character recognition device 10 then combines the extracted vertical and horizontal strokes with each other and extracts a character pattern of the input character image [symbol] .

Further, the character recognition device 10 extracts the vertical stroke(s) and the horizontal stroke(s) from the input character image, for example, [symbol] by using the number of vertical strokes, for example, “2” and the number of horizontal strokes, for example, “2” which is information about the structure of the character category, for example, [symbol] stored in the character structure dictionary storage part. The character recognition device 10 then combines the extracted vertical and horizontal strokes with each other and extracts a character pattern of the input character image [symbol] .

If the character patterns are extracted from all character categories stored in the character structure dictionary storage part, a great amount of processing time will be required, and therefore, the number of the character categories corresponding to the character patterns extracted from the input character image is limited to some extent by using prior arts. Namely, the character recognition device 10 applies a conventionally used character recognition processing to the input character image, determines the resulting candidates obtained from the character recognition processing as the character categories, and extracts the character patterns by using the structural information of the character categories.

The character recognition device 10 then compares the extracted character patterns with the respective character categories stored in the structure dictionary storage part to calculate the similarities. The character recognition device 10 then outputs as the recognition result of the input character image the character category with the maximum similarity obtained by the calculation or the information of the characters which are the candidates of the character category whose similarities have been calculated (see, FIG. 10 (2)).

When it is specifically described using the above example, the character recognition device 10 determines the vertical strokes of the character pattern of the extracted character image [symbol] as “T1” and “T2” successively from left to right and determines the horizontal strokes as “Y1” and “Y2” successively from top to bottom. The character recognition device 10 then determines the positional information (contact information) of “T1” and “Y1” as “T1×Y1, 0%, 0%”. “T1×Y1, 0%, 0%” represents that the vertical stroke “T1” and the horizontal stroke “Y1” are in contact with each other at the position where the ratio of the length from the upper end of the vertical stroke “T1” is “0%” and the ratio of the length from the left end of the horizontal stroke “Y1” is “0%”.

Likewise, the character recognition device 10 determines the positional information of “T2” and “Y1” as “T2×Y1, 0%, 100%”, the positional information of “T1” and “Y2” as “T1×Y2, 100%, 0%”, and the positional information of “T2” and “Y2” as “T2×Y2, 100%, 100%”.

Subsequently, the character recognition device 10 compares the positional information of the extracted character pattern with the positional information of each of the character categories (for example, [symbol] and [symbol] ) stored in the character structure dictionary storage part to calculate the evaluation value (similarity).

When the evaluation value is calculated, for example, a value of the positional information of the character pattern and the character category is calculated, or Euclidean distance between two points is calculated from the positional information. When the calculated value is less than a predetermined threshold value, the evaluation value is determined to be matched “TRUE” (distance is close), and when the calculated value is not less than the predetermined threshold value, the evaluation value is determined to be not matched “FALSE”. The character recognition device 10 then calculates as the evaluation value the number of evaluation items which are determined to be matched “TRUE” among all the evaluation items.

Thereafter, the character recognition device 10 outputs as the recognition result of the input character image [symbol] the character category [symbol] with the maximum evaluation value obtained by the above calculation. As the recognition result of the input character image, the character categories which are the candidates of the character category whose evaluation values have been calculated and the information including the character codes of the character categories and the calculated evaluation values may be output, or the top several character categories with higher evaluation values may be output.

Namely, the character recognition device 10 can extract the character patterns based on the vertical strokes and the horizontal strokes of the character categories corresponding to the input character image and output, for example, the character category with the maximum evaluation value of the positional information of the extracted character pattern and the character category or the candidate character categories, whereby a higher accuracy character recognition can be realized while reducing the processing load.

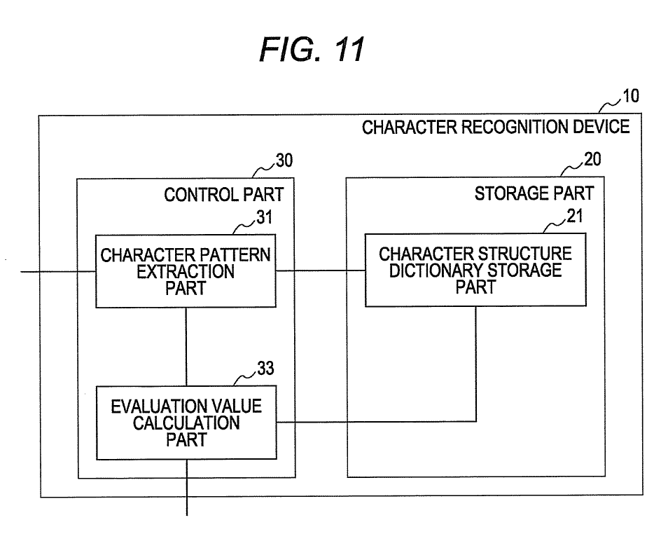

Next, a configuration of the character recognition device 10 according to an embodiment is described using FIG. 11. FIG. 11 depicts the configuration of the character recognition device 10 according to an embodiment.

As depicted in FIG. 11, the character recognition device 10 includes the storage part 20 and the control part 30. The character recognition device 10 recognizes a character image input from a scanner, a medium, or the like connected to the character recognition device 10 and outputs a character as the recognition result of the character image.

The storage part 20 stores data required for various processing performed by the control part 30 and various processing result from the control part 30 and, in particular, includes the character structure dictionary storage part 21.

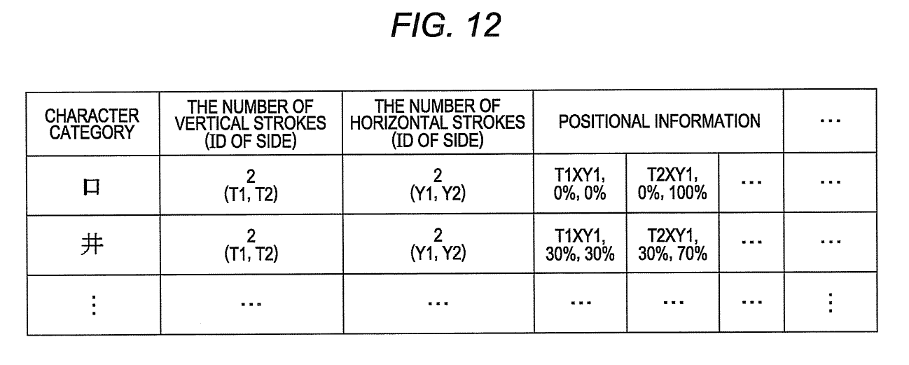

The character structure dictionary storage part 21 stores the information about the structure of the character categories in association with the character categories, each of which representing a character to be output after recognition of the input character image. Specifically, the character structure dictionary storage part 21, as depicted in FIG. 12, stores the number and side IDs (IDs of strokes) of vertical strokes, the number and side IDs (IDs of strokes) of horizontal strokes, and the positional information of a character category, which represents a character to be output after recognition of the input character image, in association with the character category.

For example, the character structure dictionary storage part 21, as depicted in FIG. 12, stores the number of vertical strokes “2” and the side IDs “T1” and “T2”, the number of horizontal strokes “2” and the side IDs “Y1” and “Y2”, the positional information “T1×Y1, 0%, 0%”, and so on of the character category [symbol] , in association with the character category [symbol] . FIG. 12 depicts an example of information stored in the character structure dictionary storage part 21.

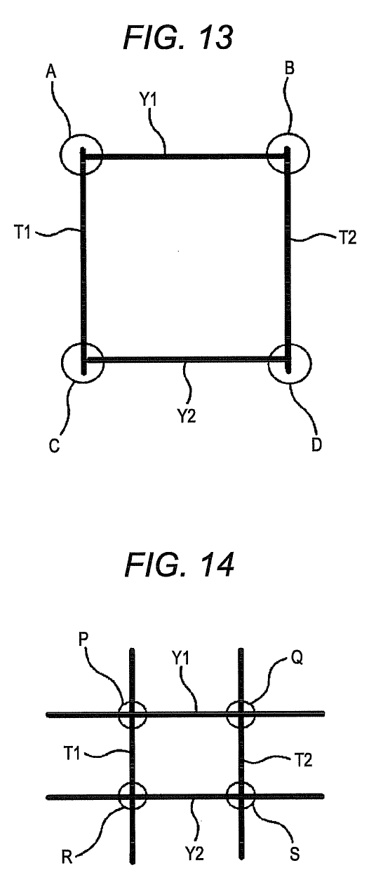

As depicted in FIG. 13, for example, the positional information of the character category [symbol] stored in the character structure dictionary storage part 21 are A “T1×Y1, 0%, 0%”, B “T2×Y1, 0%, 100%”, C “T1×Y2, 100%, 0%”, and D “T2×Y2, 100%, 100%”. “T1×Y1, 0%, 0%” represents that the vertical stroke “T1” and the horizontal stroke “Y1” are in contact with each other at the position where the ratio of the length from the upper end of the vertical stroke “T1” is “0%” and the ratio of the length from the left end of the horizontal stroke “Y1” is “0%”. FIG. 13 explains the positional information of the character category [symbol] .

Further, for example, the character structure dictionary storage part 21, as depicted in FIG. 12, stores the number of vertical strokes “2” and the side IDs “T1” and “T2”, the number of horizontal strokes “2” and the side IDs “Y1” and “Y2”, the positional information “T1×Y1, 30%, 30%”, and so on of the character category [symbol] , in association with the character category [symbol] .

The positional information of the character category [symbol] stored in the character structure dictionary storage part 21 are, for example, as depicted in FIG. 14, P “T1×Y1, 30%, 30%”, Q “T2×Y1, 30%, 70%”, R “T1×Y2, 70%, 30%”, and S “T2×Y2, 70%, 70%”. “T1×Y1, 30%, 30%” represents that the vertical stroke “T1” and the horizontal stroke “Y1” intersect with each other at the position where the ratio of the length from the upper end of the vertical stroke “T1” is “30%” and the ratio of the length from the left end of the horizontal stroke “Y1” is “30%”. FIG. 14 explains the positional information of the character category [symbol] .

The control part 30 includes an internal memory for storing control program(s), program(s) specifying procedure(s) of various processing or the like, and required data. In particular, the control part 30 includes the character pattern extraction part 31 and an evaluation value calculation part 33 and performs various processing by using these parts.

The character pattern extraction part 31 extracts a character pattern based on the information of the input character image and the information about the structure of a character category stored in the character structure dictionary storage part 21. Specifically, for example, the character pattern extraction part 31 extracts the vertical strokes and the horizontal strokes from the input character image [symbol] by using the number of vertical strokes “2” and the number of horizontal strokes “2” which are the information about the structure of the character category [symbol] stored in the character structure dictionary storage part 21.

The character pattern extraction part 31 then combines the extracted vertical and horizontal strokes with each other and extracts a character pattern of the input character image [symbol] . The character pattern extraction part 31 applies the character pattern extraction processing to all the character categories stored in the character structure dictionary storage part 21 or to a limited number of character categories where the number is limited to some extent.

The evaluation value calculation part 33 compares the character patterns extracted by the character pattern extraction part 31 with the respective character categories stored in the character structure dictionary storage part 21 to calculate the similarities. The evaluation value calculation part 33 then outputs as the recognition result of the input character image the character category with the maximum similarity obtained by the calculation or the information of the characters which are the candidates of the character category whose similarities have been calculated.

When it is specifically described using the above example, the evaluation value calculation part 33 determines the vertical strokes of the extracted character pattern of the character image [symbol] as “T1” and “T2” successively from left to right and determines the horizontal strokes as “Y1” and “Y2” successively from top to bottom. The evaluation value calculation part 33 then determines the positional information of “T1” and “Y1” as “T1×Y1, 0%, 0%”. “T1×Y1, 0%, 0%” represents that the vertical stroke “T1” and the horizontal stroke “Y1” are in contact with each other at the position where the ratio of the length from the upper end of the vertical stroke “T1” is “0%” and the ratio of the length from the left end of the horizontal stroke “Y1” is “0%”.

Likewise, the evaluation value calculation part 33 determines the positional information of “T2” and “Y1” as “T2×Y1, 0%, 100%”, the positional information of “T1” and “Y2” as “T1×Y2, 100%, 0%”, and the positional information of “T2” and “Y2” as “T2×Y2, 100%, 100%”.

Subsequently, the evaluation value calculation part 33 compares the positional information of the extracted character patterns with the positional information of the respective character categories (for example, [symbol] and [symbol] ) stored in the character structure dictionary storage part 21 to calculate the evaluation values. When the evaluation value is calculated, for example, a value of the positional information of the character pattern and the character category is calculated, or the Euclidean distance between two points is calculated from the positional information. When the calculated value is less than a predetermined threshold value, the evaluation value is determined to be matched “TRUE” (distance is close), and when the calculated value is not less than the predetermined threshold value, the evaluation value is determined to be not matched “FALSE”.

In detail, when each value of the positional information “0%, 0%” of the vertical and horizontal strokes “T1” and “Y1” of the extracted character pattern and the character category stored in the character structure dictionary storage part 21 is less than a predetermined value, the evaluation value is determined to be matched “TRUE”. When each of these values is not less than the predetermined threshold value, the evaluation value is determined to be not matched “FALSE”. For example, when the positional information of the extracted character pattern is “T1×Y1, 20%, 50%” and the positional information of the compared character category is “T1×Y1, 23%, 49%”, the evaluation value is output as being matched “TRUE”.

The evaluation value calculation part 33 calculates “evaluation value=K÷Cn” from the number of all conditions “Cn” and the number “K” of the evaluation values which are determined to be matched “TRUE” and outputs as the recognition result of the input character image [symbol] the character category [symbol] with the maximum evaluation value obtained by the calculation. As the recognition result of the input character image, the character categories which are the candidates of the character category whose evaluation values have been calculated and the information including the character codes of the character categories and the calculated evaluation values may be output, or the top several character categories with higher evaluation values may be output.

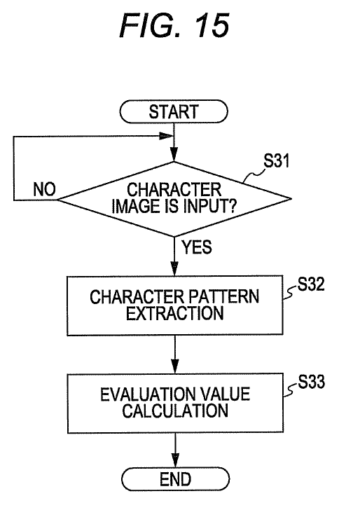

Next, a character recognition processing by the character recognition device 10 according to the third embodiment is described using FIG. 15. FIG. 15 is a flow chart for explaining the character recognition processing by the character recognition device 10 according to an embodiment.

As depicted in FIG. 15, when a character image is input including from a predetermined device, a predetermined medium, or the like (Yes in operation S31), the character recognition device 10 extracts a character pattern based on the information of the input character image and the information about the structure of a character category stored in the character structure dictionary storage part 21 (operation S32).

For example, when the character image [symbol] is input from a scanner, a medium (CD-R, etc.), or the like, the character recognition device 10 extracts the vertical strokes and the horizontal strokes from the input character image [symbol] by using the number of vertical strokes “2” and the number of horizontal strokes “2” which are the information about the structure of the character category [symbol] stored in the character structure dictionary storage part 21. The character recognition device 10 then combines the extracted vertical and horizontal strokes with each other and extracts a character pattern of the input character image [symbol] .

Further, after extracting the character pattern of the character category [symbol] , the character recognition device 10 extracts the vertical strokes and the horizontal strokes by using the number of vertical strokes “2” and the number of horizontal strokes “2” which are the information about the structure of the character category [symbol] stored in the character structure dictionary storage part 21. The character recognition device 10 then combines the extracted vertical and horizontal strokes with each other and extracts a character pattern of the input character image [symbol] .

Subsequently, the character recognition device 10 compares the extracted character patterns with the respective character categories stored in the character structure dictionary storage part 21 to calculate the similarities. The character recognition device 10 then outputs as the recognition result of the input character image the character category with the maximum similarity obtained by the calculation or the information of the characters which are the candidates of the character category whose similarities have been calculated (operation S33).

For example, the character recognition device 10 determines the vertical strokes of the extracted character pattern of the character image [symbol] as “T1” and “T2” successively from left to right and the horizontal strokes as “Y1” and “Y2” successively from top to bottom. The character recognition device 10 then determines the positional information of “T1” and “Y1” as “T1×Y1, 0%, 0%”. Likewise, the character recognition device 10 determines the positional information of “T2” and “Y1” as “T2×Y1, 0%, 100%”, the positional information of “T1” and “Y2” as “T1×Y2, 100%, 0%”, and the positional information of “T2” and “Y2” as “T2×Y2, 100%, 100%”.

The character recognition device 10 then compares positional information of the extracted character pattern(s) with positional information of the respective character categories (for example, [symbol] and [symbol] ) stored in the character structure dictionary storage part 21 to calculate evaluation values. When each value of the positional information “0%, 0%” of the vertical and horizontal strokes “T1” and “Y1” of the extracted character pattern and the character category stored in the character structure dictionary storage part 21 is less than a predetermined value, the character recognition device 10 determines the evaluation value as being matched “TRUE”, and when the value is not less than the predetermined value, the character recognition device 10 determines the evaluation value as being not matched “FALSE”.

The character recognition device 10 calculates “evaluation value=K÷Cn” from the number of all conditions “Cn” and the number “K” of the evaluation values which are determined to be matched “TRUE” and outputs as the recognition result of the input character image “□” the character category [symbol] with the maximum evaluation value obtained by the calculation. As the recognition result of the input character image, the character categories which are the candidates of the character category whose evaluation values have been calculated and the information including the character codes of the character categories and the calculated evaluation values may be output, or the top several character categories with higher evaluation values may be output.

The character recognition device 10 according to an embodiment calculates the evaluation values (similarities) based on the positional information of the vertical and horizontal segments of the input character image and can output the character category with the maximum evaluation value obtained by the calculation or the candidate character categories, whereby a higher accuracy character recognition can be realized while reducing the processing load.

In embodiments discussed above, a character pattern is extracted based on the numbers of the vertical and horizontal segments of the input image, and the similarities or the evaluation values between the extracted character patterns and the character categories corresponding to the character pattern are calculated and output; however, the present invention is not limited thereto. A character pattern may be extracted based on the numbers of the vertical and horizontal segments of the input image, and of the extracted character pattern and the character categories corresponding to the character patterns, higher character categories which are in an inclusion relation may be output.

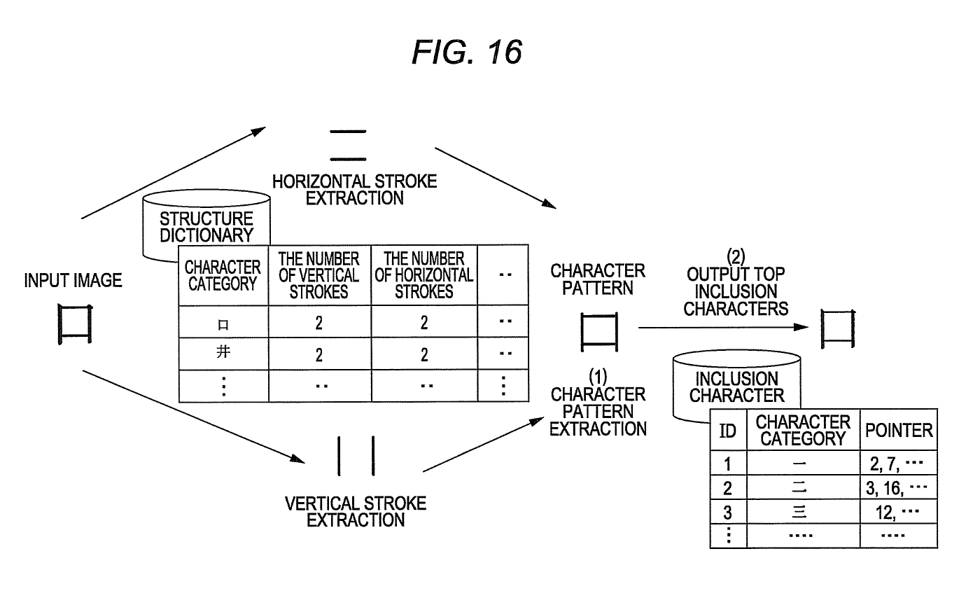

Thus, in an embodiment, a character pattern is extracted based on numbers of vertical and horizontal segments of the input image, and of the extracted character patterns and the character categories corresponding to the character patterns, higher character categories which are in the inclusion relation are output. FIGS. 16 to 20 are used for the description.

First, the outline of the character recognition device 10 according to an embodiment is described using FIG. 16. FIG. 16 depicts the outline of the character recognition device 10 according to an embodiment. In the following case, the character image [symbol] is input.

The character recognition device 10 stores information about the structures of character categories in the structure dictionary storage part in association with the character categories, each of which representing a character to be output after recognition of the input character image. Further, in the character recognition device 10, inclusion character information is stored in an inclusion character storage part. The inclusion character information depicts for all character categories that a first predetermined character category includes as its part a second predetermined character category.

The character recognition device 10 extracts a character pattern, which is compared with a character category in the recognition of the input character image, based on the information of the input character image and the information about the structure of the character category stored in the structure dictionary storage part (see, FIG. 16 (1)).

Specifically, the character recognition device 10 extracts the vertical strokes and the horizontal strokes from the input character image [symbol] by using the number of vertical strokes “2” and the number of horizontal strokes “2” which are the information about the structure of the character category [symbol] stored in the character structure dictionary storage part. The character recognition device 10 then combines the extracted vertical and horizontal strokes with each other and extracts a character pattern of the input character image [symbol] .

Further, the character recognition device 10 extracts the vertical strokes and the horizontal strokes from the input character image [symbol] by using the number of vertical strokes “2” and the number of horizontal strokes “2” which are the information about the structure of the character category [symbol] stored in the character structure dictionary storage part. The character recognition device 10 then combines the extracted vertical and horizontal strokes with each other and extracts a character pattern of the input character image [symbol] .

If the character patterns are extracted from all character categories stored in the character structure dictionary storage part, a great amount of processing time will be required, and therefore, the number of the character categories corresponding to the character patterns extracted from the input character image is limited to some extent by using prior arts. Namely, the character recognition device 10 applies a conventionally used character recognition processing to the input character image, determines the resulting candidates obtained from the character recognition processing as the character categories, and extracts the character patterns by using the structural information of the character categories.

The character recognition device 10 then outputs as the recognition result of the input character image the character category which is the uppermost of the character categories corresponding to the extracted character patterns and stored in the inclusion character storage part, or the information of the characters which are the candidates of the character category (see, FIG. 16(2)).

When it is specifically described using the above example, the character recognition device 10 outputs as the recognition result of the input character image [symbol] the character category [symbol] which is the uppermost character category of the character categories corresponding to the extracted character patterns and stored in the inclusion character storage part (for example, [symbol] , and [symbol] ), or the information of, for example, the character categories [symbol] and [symbol] which are the candidates of the character category.

Here, an inclusion character refers to a character which includes the structural information (strokes) of, for example, the character category [symbol] . The character category [symbol] includes the structural information of, for example, [symbol] and [symbol] , whereby [symbol] , and [symbol] are the inclusion characters of [symbol] .

Namely, the character recognition device 10 can extract a character pattern based on the vertical strokes and the horizontal strokes of a character category corresponding to the input character image and, out of the character categories corresponding to the extracted character patterns, can output the uppermost character category in the inclusion relation or the candidate character categories, whereby a higher accuracy character recognition can be realized while reducing the processing load.

In other words, even for a character category such as [symbol] having a plurality of inclusion characters, the character recognition device 10 can output as the recognition result of the input character image the character category which is the uppermost of the inclusion characters, whereby a higher accuracy character recognition can be realized.

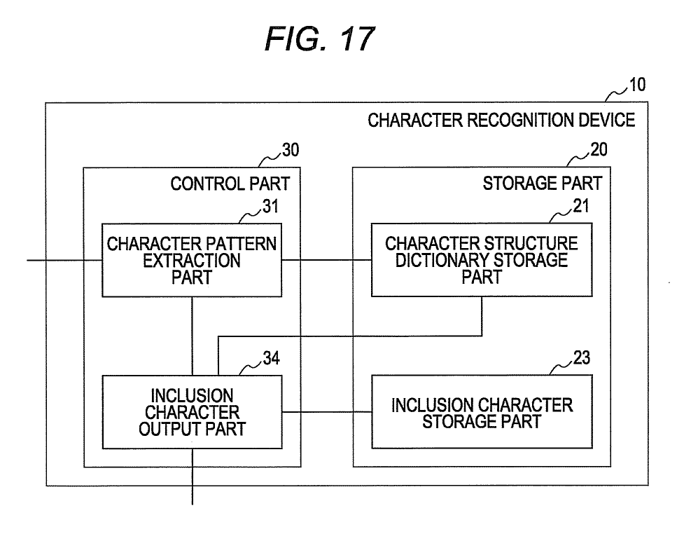

Next, the configuration of the character recognition device 10 according to an embodiment is described using FIG. 17. FIG. 17 depicts a configuration of the character recognition device 10 according to the fourth embodiment.

As depicted in FIG. 17, the character recognition device 10 includes the storage part 20 and the control part 30. The character recognition device 10 recognizes a character image input from a scanner, a medium, or the like connected to the character recognition device 10 and outputs a character as the recognition result of the character image.

The storage part 20 stores data required for various processing performed by the control part 30 and result(s) of the various processing by the control part 30 and, in particular, includes the character structure dictionary storage part 21 and an inclusion character storage part 23.

The character structure dictionary storage part 21 stores the information about the structures of character categories in association with the respective character categories, each of which representing a character to be output after recognition of the input character image. For example, the character structure dictionary storage part 21 stores the information about the structure including the number of vertical strokes “2” and the number of horizontal strokes “2” of the character category [symbol] in association with the character category [symbol] representing a character to be output after recognition of the input character image [symbol] .

Further, for example, the character structure dictionary storage part 21 stores the information about the structure including the number of vertical strokes “2” and the number of horizontal strokes “2” of the character category [symbol] in association with the character category [symbol] representing a character to be output after recognition the input character image [symbol] .

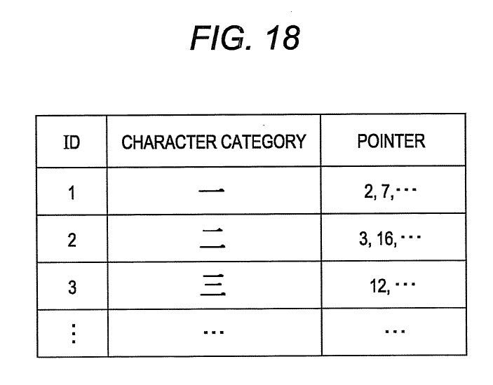

The inclusion character storage part 23 stores the inclusion character information indicating, for all character categories, that a first predetermined character category includes as its part a second predetermined character category. Specifically, the inclusion character storage part 23, as depicted in FIG. 18, stores “character category” and “Pointer” in association with “ID” representing identifiers of all character categories. The “Pointer” represents IDs of the character categories including the character category as an inclusion character.

For example, the inclusion character storage part 23, as depicted in FIG. 18, stores the character category [symbol] and the pointer “2, 7, . . . ” in association with the ID “1” representing the identifiers of all the character categories. The pointer “2” refers to the character category [symbol] FIG. 18 depicts an example of information stored in the inclusion character storage part 23.

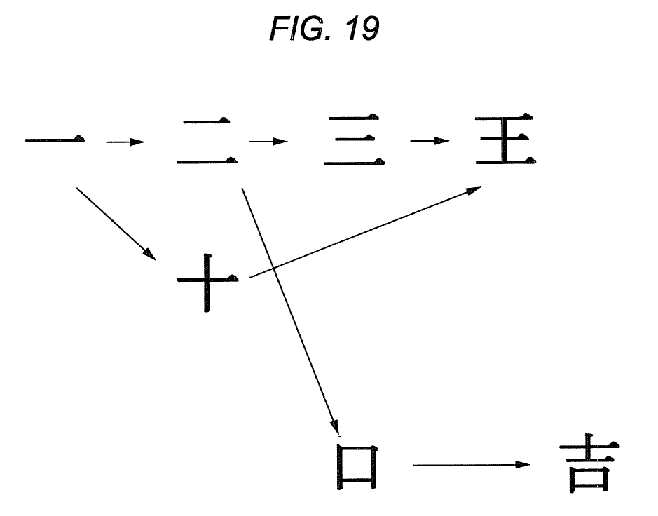

The information stored in the inclusion character storage part 23, as depicted in FIG. 19, for example, depicts the relation between a predetermined character category [symbol] and a character category [symbol] or [symbol] including [symbol] as an inclusion character. Namely, the character category [symbol] includes the inclusion characters such as [symbol] and [symbol] . FIG. 19 depicts an image of a digraph in the inclusion characters.

The control part 30 includes an internal memory for storing control programs, programs specifying procedures of various processing and the like, and required data. In particular, the control part 30 includes a character pattern extraction part 31 and an inclusion character output part 34 and performs various processing by using these parts.

The character pattern extraction part 31 extracts a character pattern based on the information of the input character image and the information about the structure of a character category stored in the character structure dictionary storage part 21. Specifically, for example, the character pattern extraction part 31 extracts the vertical strokes and the horizontal strokes from the input character image [symbol] stored in the character structure dictionary storage part 21 by using the number of vertical strokes “2” and the number of horizontal strokes “2” which are the information about the structure of the character category [symbol] stored in the character structure dictionary storage part 21.

The character pattern extraction part 31 then combines the extracted vertical and horizontal strokes with each other and extracts a character pattern of the input character image [symbol] . The character pattern extraction part 31 applies the character pattern extraction processing to all the character categories stored in the character structure dictionary storage part 21 or to some character categories where the number is limited to some extent.

The inclusion character output part 34 outputs as a recognition result of the input character image the character category which is the uppermost of the character categories corresponding to the extracted character patterns and stored in the inclusion character storage part 23, or the information of the characters which are the candidates of the character category.

When it is specifically described using the above example, the inclusion character output part 34 outputs as the recognition result of the input character image [symbol] the uppermost character category [symbol] of the character categories (for example, [symbol] , and [symbol] ) corresponding to the character patterns extracted by the character pattern extraction part 31 and stored in the inclusion character storage part 23, or the information of the character categories such as [symbol] and [symbol] which are the candidates of the character category.

For example, when the character patterns are extracted from the input image [symbol] and, as a result, the character categories corresponding to the input image [symbol] are [symbol] [symbol] , and [symbol] , the inclusion character output part 34 acquires each of the inclusion characters of the character categories by using the inclusion character storage part 23. The inclusion character output part 34 then outputs, as the recognition result, the character category [symbol] which is the uppermost of the inclusion characters of the character categories.

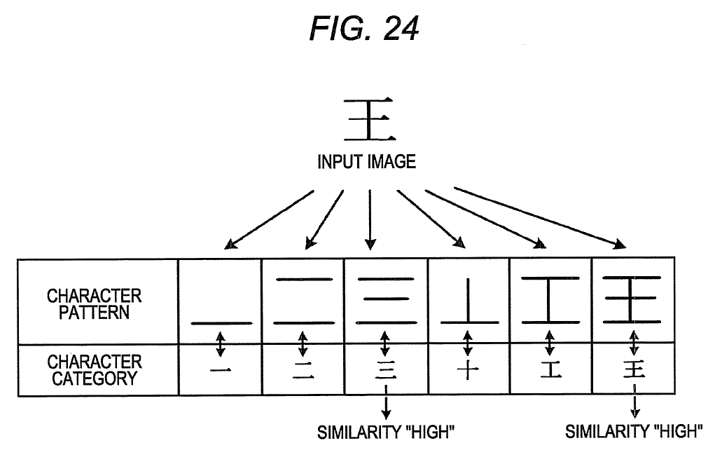

Namely, as depicted in the example of FIG. 24, regarding the character categories [symbol] and [symbol] whose similarities as the recognition result with the input image [symbol] are high to some extent, the character category [symbol] is an inclusion character of the character category [symbol] . Therefore, the inclusion character output part 34 outputs as the recognition result the character category [symbol] which is the top of the inclusion characters. FIG. 24 depicts the character categories whose similarities are higher when the character image [symbol] is input.

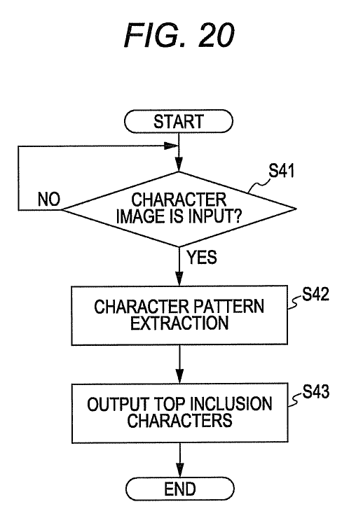

Next, the character recognition processing by the character recognition device 10 according to the fourth embodiment is described using FIG. 20. FIG. 20 is a flow chart for explaining the character recognition processing by the character recognition device 10 according to the fourth embodiment.

As depicted in FIG. 20, when a character image is input (Yes in operation S41), the character recognition device 10 extracts a character pattern based on information of the input character image and information about a structure of a character category stored in the character structure dictionary storage part 21 (operation S42).

For example, when the character image [symbol] is input from a scanner, a medium (CD-R, etc.), or the like, the character recognition device 10 extracts the vertical strokes and the horizontal strokes from the input character image [symbol] by using the number of vertical strokes “2” and the number of horizontal strokes “2” which are the information about the structure of the character category [symbol] stored in the character structure dictionary storage part 21. The character recognition device 10 then combines the extracted vertical and horizontal strokes with each other and extracts a character pattern of the input character image [symbol] .

After extracting the character pattern of the character category [symbol] , the character recognition device 10 extracts vertical stroke(s) and horizontal stroke(s) by using the number of vertical strokes, for example, “2” and the number of horizontal strokes, for example, “2” which is information about the structure of the character category, for example, [symbol] stored in the character structure dictionary storage part 21. The character recognition device 10 then combines the extracted vertical and horizontal strokes with each other and extracts a character pattern of the input character image [symbol] .

The character recognition device 10 then outputs as a recognition result of the input character image the character category which is the uppermost of the character categories corresponding to the extracted character patterns and stored in the inclusion character storage part 23, or the information of the characters which are the candidates of the character category (operation S43).

For example, the character recognition device 10 outputs as the recognition result of the input character image [symbol] the uppermost character category [symbol] of the character categories (for example, [symbol] , and [symbol] ) corresponding to the character patterns extracted by the character pattern extraction part and stored in the inclusion character storage part 23, or the information of the character categories, for example, [symbol] and [symbol] which are the candidates of the character category.

The character recognition device 10 according to an embodiment can extract a character pattern based on the vertical and horizontal strokes of a character category corresponding to an input character image and output the character category which is the uppermost in the inclusion relation of the character categories corresponding to the extracted character patterns, or the candidate character categories, whereby a higher accuracy character recognition can be realized.

Although the embodiments of the present invention have been described, the present invention may be applied to various different embodiments in addition to the above embodiments. Thus, embodiments different in structural information of a character category, using a binarized parameter, using the similarity calculation and the inclusion character output, the configuration of the character recognition device, and a program are hereinafter described.

(1) Structural Information of Character Category

In the above discussed embodiments, a character pattern of an input character image is extracted by using the numbers of vertical and horizontal segments (strokes) as the structural information of a character category; however, the present invention is not limited thereto. A character pattern of an input character image can also be extracted by using the numbers of diagonal strokes, closed circuits, and so on as the structural information of a character category. For example, in the character recognition device 10, the structural information of [symbol] having the diagonal strokes, [symbol] including the closed circuit, and the like is stored in the character structure dictionary storage part 21 for storing the structural information of character categories. The character recognition device 10 then extracts character patterns of an input character image such as [symbol] and [symbol] by using the structural information stored in the character structure dictionary storage part 21. The character recognition device 10 may extract character patterns of not only kanji, for example, but also any character having the structural information of character categories, such as hiragana, Roman, or any other type of letters.

(2) Using Binarized Parameter

In the above discussed embodiments, a character pattern is extracted by using the dynamic programming; however, the present invention is not limited thereto. A character pattern can be extracted while changing a binarized parameter. For example, in the character pattern extraction by the binarized parameter, the extracted character pattern blurs when the binarized parameter is small, and the extracted character pattern is collapsed or noise is generated when the binarized parameter is large. The character recognition device 10 extracts the segments by using the number of the segments of the character category while changing the binarized parameter, whereby the character recognition device 10 extracts the character pattern by always using the number of the segments.

(3) Using Similarity Calculation and Inclusion Character Output

In above discussed embodiments, the character recognition processing is performed using any one of the similarity calculation, the evaluation value calculation, and the inclusion character output; however, the present invention is not limited thereto. The character recognition processing can be performed using the similarity calculation and/or the evaluation value calculation, and the inclusion character output.

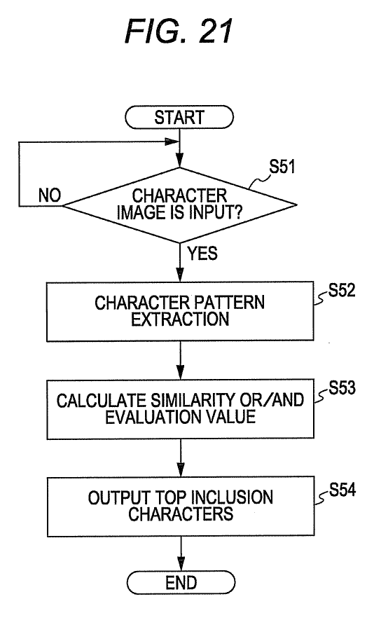

A flow of the character recognition processing using the similarity calculation and/or the evaluation value calculation, and the inclusion character output is described below using FIG. 21. FIG. 21 is a flow chart depicting a character recognition processing using the similarity calculation and/or the evaluation value calculation, and the inclusion character output.

As depicted in FIG. 21 when a character image is input (Yes in operation S51), the character recognition device 10 extracts a character pattern based on information of the input character image and information about the structure of a character category stored in the character structure dictionary storage part 21 (operation S52).

For example, when the character image [symbol] is input from a scanner, a medium (CD-R, etc.), or the like, the character recognition device 10 extracts the vertical strokes and the horizontal strokes from the input character image [symbol] by using the number of vertical strokes “2” and the number of horizontal strokes “2” which are the information about the structure of the character category [symbol] stored in the character structure dictionary storage part 21. The character recognition device 10 then combines the extracted vertical and horizontal strokes with each other and extracts a character pattern of the input character image [symbol] .

The character recognition device 10 then compares the extracted character patterns with the respective character categories corresponding to the character patterns to calculate the similarities. The character recognition device 10 then outputs as a recognition result of the input character image the character category with the maximum similarity obtained by the calculation or the information of the characters which are the candidates of the character category whose similarities have been calculated (operation S53).

For example, the character recognition device 10 calculates the similarities as used in the above discussed embodiments or the evaluation values as used in an embodiment and outputs the top several character categories which are the candidates of the character recognition result. By using both the similarity and the evaluation value, a value obtained by adding the calculated evaluation value to the calculated similarity may be used to output the candidates of the character recognition result.

Subsequently, the character recognition device 10 outputs as a recognition result of the input character image the character category which is the uppermost of the output character categories stored in the inclusion character storage part 23, or the information of the characters which are the candidates of the character category (operation S54).

For example, the character recognition device 10 outputs as the recognition result of the input character image [symbol] the uppermost character category [symbol] of the output character categories (for example, [symbol] , and [symbol] ) stored in the inclusion character storage part 23, or the information of the character categories such as [symbol] and [symbol] which are the candidates of the character category.

Namely, the character recognition device 10 can output the uppermost character category in the inclusion character relation among the character category candidates which are higher in the similarities and/or the evaluation values between the extracted character patterns and the character categories corresponding to the character patterns or the top several character categories of the candidate character categories, whereby a higher accuracy character recognition can be realized.

In addition, the processing procedures, the control procedures, the specific names, the information including various data and parameters (for example, the structural information of the character category stored in, for example, “the character structure dictionary storage part 21” depicted in FIG. 2) described above or depicted in the drawings can be changed as necessary unless stated otherwise.

Moreover, each component of the illustrated devices is functionally conceptual, and is not necessarily required to be physically configured as depicted in the drawings. In other words, specific forms of distribution and integration of the respective devices are not limited to those depicted in the drawings and the whole or a part of the respective components can be configured by functionally or physically distributing or integrating them in any unit depending on various loads, usage statuses, and the like. For example, the character pattern extraction part 31 may be distributed into a character image receiving part for receiving an input character image and a character pattern extraction part for extracting a character pattern of the received character image, or the similarity calculation part 32 may be distributed into a similarity calculation part for calculating the similarity between an extracted character pattern and a character category corresponding to the character pattern and a recognition result output part for outputting the character category with the maximum similarity obtained by calculation. Furthermore, the whole or a part of the respective processing functions performed in the respective devices can be realized by a CPU and a program analyzed and executed by the CPU, or can be realized as wired-logic hardware.

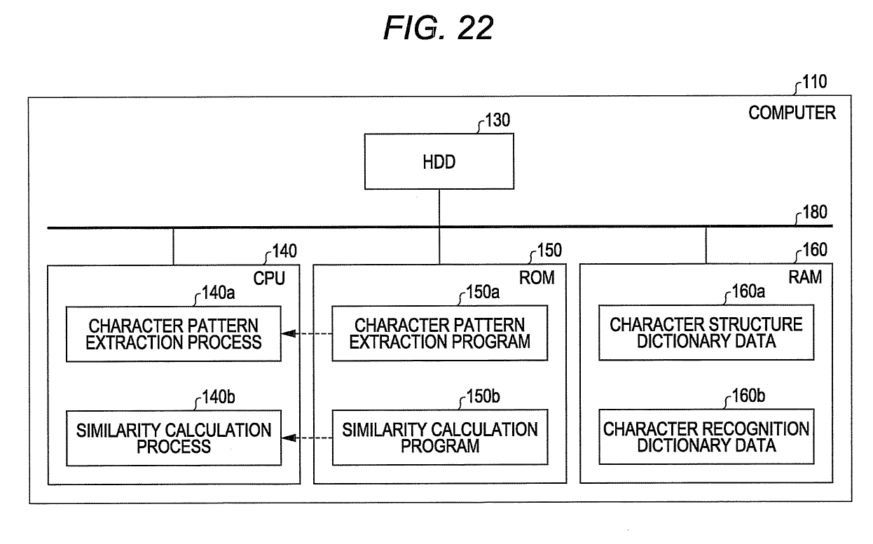

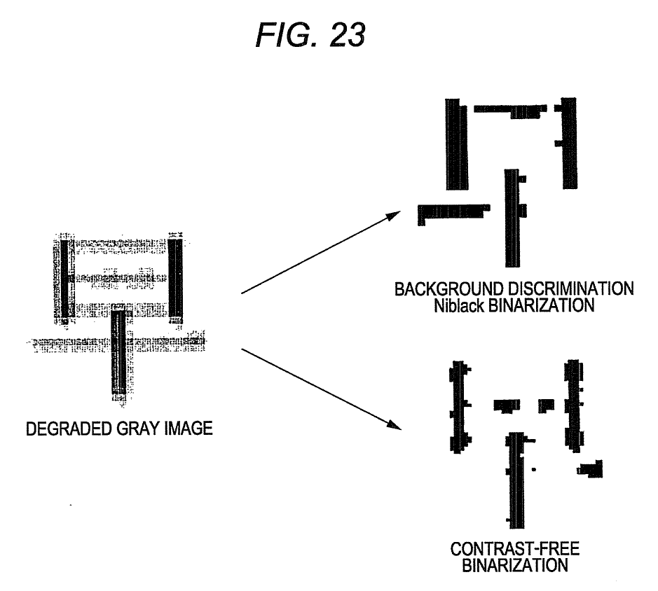

In the above embodiments, various processing is realized by hardware logic; however, the present invention is not limited thereto, and a previously provided program may be executed by a computer, whereby various processing may be realized. Thus, an example of a computer for executing a character recognition program having a function similar to the character recognition device 10 depicted in the above embodiments is described below using FIG. 22. FIG. 22 depicts a computer for executing a character recognition program.

As depicted in FIG. 22, a computer 110 as a character recognition device is connected with an HDD 130, a CPU 140, a ROM 150, and a RAM 160 through a bus 180 or the like.

A character recognition program fulfilling a function similar to the character recognition device 10 depicted in the above discussed embodiment, that is, a character pattern extraction program 150a and a similarity calculation program 150b are stored in the ROM 150 in advance, as depicted in FIG. 22. The programs 150a and 150b may be appropriately integrated or distributed as with each component of the character recognition device 10 depicted in FIG. 2.

The programs 150a and 150b function as a character pattern extraction process 140a and a similarity calculation process 140b by being read from the ROM 150 by the CPU 140. The processes 140a and 140b respectively correspond to the character pattern extraction part 31 and the similarity calculation part 32 depicted in FIG. 2.

The CPU 140 executes the character recognition program based on a character structure dictionary data 160a and a character recognition dictionary data 160b recorded in the RAM 160.

The programs 150a and 150b do not necessarily need to be stored in the ROM 150 from the beginning (at all times) and, for example, each program may be stored in a “portable physical medium” such as a flexible disk (FD), a CD-ROM, a DVD disk, a magneto optical disk, and an IC card readable by the computer 110, a “stationary physical medium” such as an HDD provided inside or outside the computer 110, or “another computer (or server)” connected to the computer 110 through a public communication line, the Internet, a LAN, a WAN, and so on, whereby the computer 110 may read out the programs 150a and 150b from these media and execute the programs.

Although a few embodiments have been depicted and described, it would be appreciated by those skilled in the art that changes may be made in these embodiments without departing from the principles and spirit of the invention, the scope of which is defined in the claims and their equivalents. All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a depicting of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A computer readable recording medium, having recorded thereon a character recognition program causing a computer to perform a process, comprising:
extracting a character pattern based on information of an input character image and information about a structure of a character category, the character category representing a character to be output after recognition of the input character image and being compared with the character pattern;
calculating a similarity between the extracted character pattern and the character category corresponding to the character pattern; and
outputting, as a recognition result of the input character image, at least one of a character category with a maximum similarity and information of characters which are candidates of the character category whose similarities have been calculated.

2. The computer readable recording medium having recorded thereon a character recognition program according to claim 1, wherein:
the extracting extracts the character pattern based on the information of the input character image and an information about the structure of the character category stored in a structure dictionary storage and stores the character pattern in a recognition dictionary storage in association with the character category, and
the calculating calculates similarity between the extracted character pattern stored in the recognition dictionary storage and the character category corresponding to the character pattern.

3. The computer readable recording medium having recorded thereon a character recognition program according to claim 2, wherein the extracting extracts the character pattern based on the information of the input character image and an information about numbers of vertical and horizontal segments of the character category stored in the structure dictionary storage.

4. The computer readable recording medium having recorded thereon a character recognition program according to claim 2, wherein
the extracting extracts the character pattern based on the information obtained by numerically converting the input character image into a white area range and a black area range and an information about numbers of vertical and horizontal segments of the character category stored in the structure dictionary storage, where the segments of the input character image are detected by dynamic programming.

5. The computer readable recording medium having recorded thereon a character recognition program according to claim 2, wherein:
the extracting extracts the character pattern based on information obtained by numerically converting the input character image into a white area range and a black area range and an information about numbers of vertical and horizontal segments of the character category stored in the structure dictionary storage, the segments of the input character image being detected by dynamic programming and a black area being added depending on a length of the segment;
the calculating a distance value between the character pattern stored in the recognition dictionary storage and the character category corresponding to the character pattern as the similarity; and
the outputting outputs at least one of the character category with a closest distance value obtained by the calculation and the information of the characters which are the candidates of the character category whose distance values have been calculated.

6. The computer readable recording medium having recorded thereon a character recognition program according to claim 1, wherein the extracting extracts the character pattern based on the information of the input character image and an information about the structure of the character category stored in a structure dictionary storage; and
the calculating calculates similarity between the extracted character pattern and a character category stored in a structure dictionary storage.

7. The computer readable recording medium having recorded thereon a character recognition program according to claim 6, wherein:
the extracting extracts the character pattern based on the information of the input character image and an information about the vertical and horizontal segments of the character category stored in a structure dictionary storage; and
the calculating calculates similarity between information about a position of the extracted character pattern and an information about the position of each segment of the character category stored in a structure dictionary storage.

8. The computer readable recording medium having recorded thereon a character recognition program according to claim 1, wherein the extracting extracts the character pattern based on the information of the input character image and an information about the structure of the character category stored in a structure dictionary storage, and
the outputting provides, as a recognition result of the input character image, at least one of the character category which is an uppermost of the outputted character categories based on an inclusion character information indicating for all character categories that a first predetermined character category includes as its part a second predetermined character category stored in an inclusion character storage, and the information of the characters which are the candidates of the character category.

9. The computer readable recording medium having recorded thereon a character recognition program according to claim 8, wherein the extracting extracts the character pattern based on the information of the input character image and the information about numbers of vertical and horizontal segments of the character category stored in the structure dictionary storage.

10. A character recognition device comprising:
character pattern extraction means for extracting a character pattern based on information of an input character image and information about a structure of a character category, the character category representing a character to be output after recognition of the input character image; and
similarity calculation means for comparing the character pattern extracted by the character pattern extraction means and the character category corresponding to the character pattern with each other to calculate the similarity, and
output means for outputting as a recognition result of the input character image a character category with a maximum similarity obtained by the calculation or information of characters which are candidates of the character category whose similarities have been calculated.

11. A character recognition method, comprising;
extracting a character pattern based on information of the input character image and information about a structure of the character category, the character category representing a character to be output after recognition of the input character image;
comparing the extracted character pattern with the character category corresponding to the character pattern to calculate the similarity; and
outputting, as a recognition result of the input character image, at least one of the character category with a maximum similarity and information of characters which are candidates of the character category whose similarities have been calculated.

12. A method of character recognition, comprising:
extracting information of an input image; and
comparing a similarity of each character across character categories corresponding to a character pattern of the input image and providing a character category having a maximum similarity with the input image as a recognition result.
